(19) United States
(12) Patent Application Publication
(10) Pub. No.: US 2021/0174253 A1
(43) Pub. Date: Jun. 10, 2021

(54) ANALYSIS OF SYSTEM LOG DATA USING MACHINE LEARNING

(71) Applicant: Triad National Security, LLC, Los Alamos, NM (US)

(72) Inventors: Elisabeth Ann Moore, Los Alamos, NM (US); Nathan A. Debardeleben, Los Alamos, NM (US); Sean P. Blanchard, Los Alamos, NM (US)

(73) Assignee: Triad National Security, LLC, Los Alamos, NM (US)

(21) Appl. No.: 17/061,956

(22) Filed: Oct. 2, 2020

Related U.S. Application Data
(60) Provisional application No. 62/946,098, filed on Dec. 10, 2019.

(51) Int. Cl. G06N 20/00; G06F 11/07; G06N 5/00

(52) U.S. Cl. CPC G06N 20/00; G06N 5/003; G06F 11/0781; G06F 11/0775

(57) ABSTRACT

Systems and methods for detecting anomalies in machine-generated logs are described. Machine-generated logs are processed and analyzed using machine learning models to determine whether a log message is anomalous. The system may use machine learning models that are configured to process particular types of log messages. An explanation for why the system detected an anomaly in the log message is also generated based on processing of the log message.

### CROSS-REFERENCE TO RELATED APPLICATION

This application claims priority to U.S. Provisional patent Application Ser. No. 62/946,098, entitled “Analysis of Computer Log Data Using Machine Learning,” filed on Dec. 10, 2019, in the names of Elisabeth Ann Moore, et al. The above provisional application is herein incorporated by reference in its entirety.

### STATEMENT REGARDING FEDERALLY SPONSORED RESEARCH OR DEVELOPMENT

The United States government has rights in this invention pursuant to Contract No. 89233218CNA000001 between the United States Department of Energy (DOE), the National Nuclear Security Administration (NNSA), and Triad National Security, LLC for the operation of Los Alamos National Laboratory.

### BACKGROUND

Computing devices and systems generate logs representing, for example, computing processes, user inputs, etc. System administrators and other users may monitor the computer-generated logs to determine if there is an anomaly and may analyze the logs to determine the cause of the anomaly. The computer-generated logs may include large amounts of data.

### SUMMARY

The present disclosure provides techniques for detecting anomalies in computing device- and computing system-generated text logs. In at least some examples, one or more machine learning techniques may be used to perform anomaly detection (e.g., one or more machine learning techniques may be used to intelligently identify unusual-looking log messages).

One embodiment provides a method that includes processing a plurality of log messages to determine a first process tag associated with a first log message and a second process tag associated with a second log message. The method further includes selecting a first machine learning model corresponding to the first process tag and processing the first log message using the first machine learning model to determine data representing a traversal path. The method also includes determining that the first log message includes an anomaly, determining an explanation for the determining that the first log message includes an anomaly, and generating output data associating the explanation with the first log message.

Some embodiments provide a method that further includes processing the first log message using the first machine learning model to determine a first score representing a likelihood that the first message includes an anomaly, where the output data is generated based on the first score.

Some embodiments provide a method that further includes processing the first log message to determine one or more features, where the first machine learning model is a trained density estimator and processing the first log message using the first machine learning model includes processing the one or more features using the trained density estimator.

Some embodiments provide a method that further includes processing the first log message using a second machine learning model to determine a relevance score corresponding to the first log message, where the second machine learning model is a Naïve Bayesian model. Some embodiments provide a method that further includes determining an anomaly score based at least in part on the first score and the relevance score, and determining that the anomaly score satisfies a condition, where the output data is generated further based on the anomaly score satisfying a condition.

### BRIEF DESCRIPTION OF DRAWINGS

For a more complete understanding of the present disclosure, reference is now made to the following description taken in conjunction with the accompanying drawings.

FIG. 1 illustrates a system configured to process machine-generated logs to detect anomalies according to embodiments of the present disclosure.

FIG. 2 is a conceptual diagram illustrating components of an anomaly detection system according to embodiments of the present disclosure.

FIG. 3A conceptually illustrates how example log messages may be to determine various features 315 corresponding to the log messages.

FIG. 3B conceptually illustrates how log messages may be grouped based on the corresponding process tags.

FIG. 4 illustrates exemplary decision trees that may be traversed to determine if a log message includes an anomaly.

FIGS. 5A and 5B illustrates example user interfaces displaying log messages.

FIG. 6 is a block diagram conceptually illustrating example components of a device according to embodiments of the present disclosure.

FIG. 7 is a block diagram conceptually illustrating example components of a server according to embodiments of the present disclosure.

### DETAILED DESCRIPTION

High performance computing (HPC) and supercomputing centers constantly need to monitor and troubleshoot their machines. The computer-generated text logs produced by these machines can amount to terabytes of data, and include information that can facilitate troubleshooting of all kinds of problems, from unintentional user errors to malicious behavior. Analysis of machine-generated text logs by system administrators or other users can be inefficient because of the massive amount of logging data. This is especially true as the HPC field approaches the exascale computing era. Such inefficiencies result in system problems being solved retroactively, and after days or weeks of the problem occurring.

The present disclosure provides systems and methods for detecting anomalies in machine-generated logs that may assist a user in efficiently identifying events of interest and efficiently troubleshoot problems.

The anomaly detection system described herein, in some embodiments, uses machine learning (ML) models to analyze/process machine-generated logs and perform context-aware anomaly detection within the machine-generated logs. The anomaly detection system described herein are configured to detect and locate unusual log messages by learning from training data and/or previous machine-generated logs. In some embodiments, the anomaly detection system may extract features, representing text and numbers included in the message and may cluster messages based on a process tag associated with the message. The anomaly detection system may select an ML model (e.g., a random forest) that is particularly configured to process messages that are associated with a particular process tag. Based on the processing of the ML model, the anomaly detection system may determine whether the log message is potentially anomalous.

The ML model may be configured to determine if the log message includes data (text and numbers) that appear to be an anomaly. However, not all messages determined to be anomalous by the ML model may be of interest to a user or may be perceived by a user as an anomaly. To make a final determination as to whether a log message is anomalous, the anomaly detection system may process the potentially anomalous log message using another ML model (e.g., a Naïve Bayes model). The other ML model may be configured to process potentially anomalous messages with respect to messages that are indicated as anomalous (positive data samples) and messages that are indicated as being non-anomalous (negative data samples).

The anomaly detection system described herein may also generate an explanation, in natural language, describing one or more reasons why the log message is indicated as anomalous. The anomaly detection system described herein may also include a user interface that assists a user in identifying anomalous messages by tagging or displaying one or more visual elements indicating that the anomalous log message. The user interface may also display the explanation for why the tagged log message is anomalous. The output of the anomaly detection system may be referred to as an annotated machine-generated log or annotated log messages.

As used herein, a machine-generated log refers to text data or a text log generated by a machine, a computing device, a computing system, a high performance computing (HPC) system, a server, a network of machines, or other machines/devices/systems. The machine-generated log may include text data describing and/or relating to events that occur during processing by the machine. Machine-generated logs may also be referred to as system logs and may follow a syslog formatting. A machine-generated log may include multiple different messages relating to multiple different events, each message may include a sequence/message identifier, a time stamp (including month, day, hour, minutes and seconds) the message was generated, a facility that generated the message (e.g., a system, a software module/component, a device, a hardware component, a protocol, etc.), a text string providing a short description of the message, and a text string providing a detailed description of the event being reported by the message. In some cases, a machine-generated log may also include numerical information in a decimal format and/or a hexadecimal format indicating a memory location, a system call number, etc. In some embodiments, the machine-generated logs include a process tag identifying the type of process/event that occurred. The systems and methods described herein can also be used to analyze/process data that is not represented as machine-generated logs and that include some information identifying different events of interest, for example, using a timestamp, a process or other type of category tag, a description, a numeric entry, and/or other information describing or relation to the event of interest.

As used herein, an anomaly refers to text data or other data within the machine-generated log that indicates deviation from a standard/normal/expected machine-generated log. An anomaly may represent an error in processing by the machine, or it may represent an event that a user indicates as being an anomaly.

In some embodiments, a user who reviews/analyzes the annotated machine-generated logs, generated by the anomaly detection system of the present disclosure, may provide feedback/input via the user interface with respect to the identified anomalous log messages. The systems and methods described herein enables a user to confirm the anomaly detection system's identification of anomalous log messages, and to flag false positives, that are log messages that are tagged as anomalous but the user determines that it is not anomalous. The anomaly detection system may use the user feedback to update or retrain the system.

In some embodiments, the systems and methods described herein may use a combination of various techniques, including, but not limited to, community detection, statistical relational learning, clustering, explainable machine learning techniques, natural language processing, and others. The systems and methods described herein may use different types of ML models, including, but not limited to, random forests/trees for density estimation, network-based models, classifiers, Naïve Bayes models, neural networks, and others.

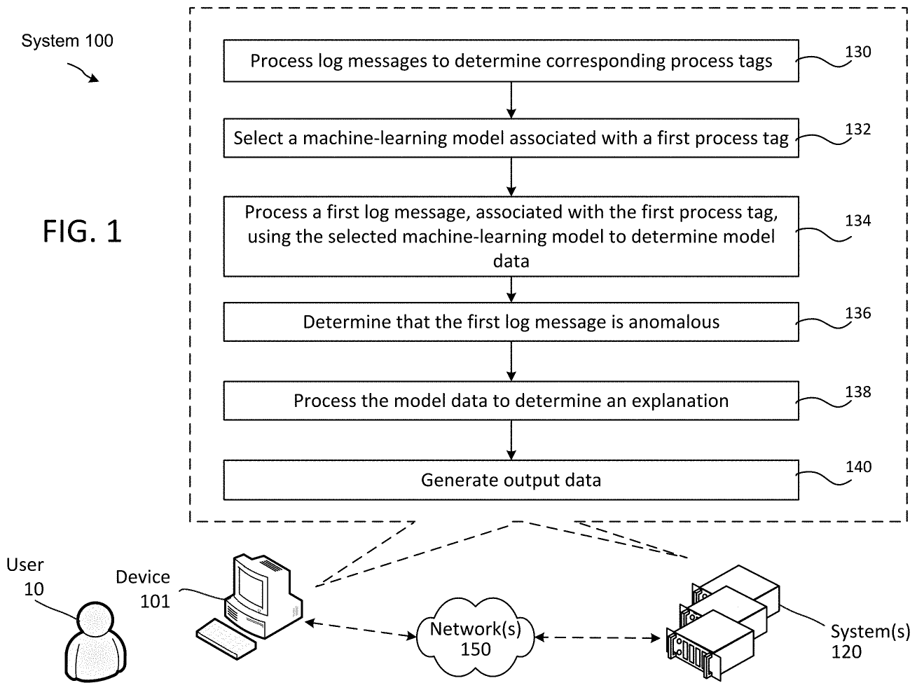

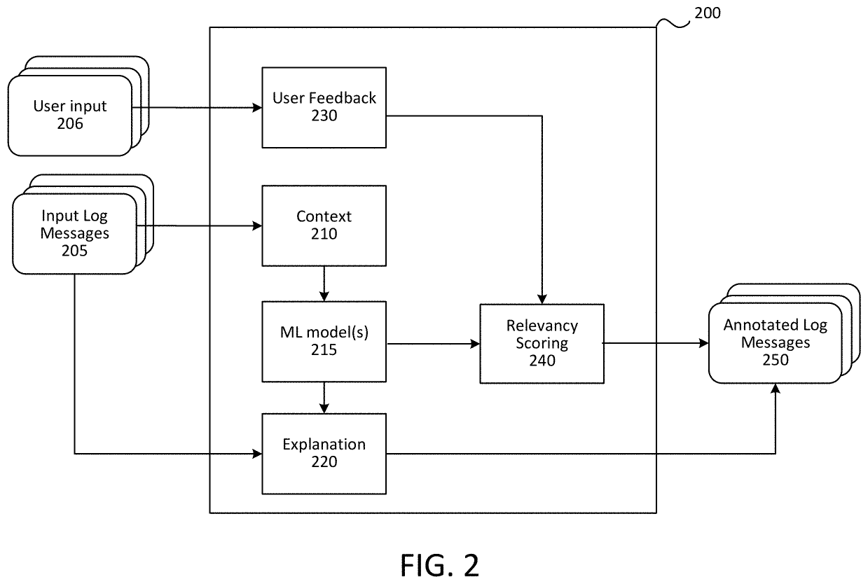

FIG. 1 illustrates a system 100 configured to process machine-generated logs to detect anomalous messages within according to embodiments of the present disclosure. As illustrated in FIG. 1, the system may include a device 101 local to a user 10 and one or more systems 120 connected across one or more networks 150. In some embodiments, the system(s) 120 may output the machine-generated logs to record and monitor occurrence of events during processing by the system(s) 120. The system(s) 120, in an example embodiment, may be an HPC system or may be a portion of an HPC system. In other embodiments, the device 101 may output the machine-generated logs to record and monitor occurrence of events during processing by the device 101. In some embodiments, the system(s) 120 may include an anomaly detection system (e.g., 200 of FIG. 2) and may be configured to process the machine-generated logs to identify anomalous log messages. In other embodiments, the device 101 may include the anomaly detection system (e.g., 200 of FIG. 2) and may be configured to process the machine-generated logs to identify anomalous log messages. The device 101, in some embodiments, may also display annotated machine-generated logs for the user 10 to review or analyze.

The system(s) 120 or the device 101 may process (130) multiple log messages to determine a process tag corresponding to each log message. The log messages may be included in a machine-generated log outputted by the system(s) 120 or the device 101. The machine-generated log may include information on events that occurred during a time period (e.g., the past 6 hours, the past 12 hours, the past 24 hours, etc.). A log message in the machine-generated log may include, in addition to other data, a message identifier, a timestamp and text data describing the event that occurred. The log message, in some embodiments, may also include a process tag identifying the type of process or event that occurred. In some embodiments, the log message may not include a process tag. The system(s) 120 or the device 101 may identify a first process tag included in the log message, and may store data associating the first process tag with the log message and the message identifier. In some embodiments, the system(s) 120 or the device 101 may process the text data in the log message to determine a first process tag associated with the log message based on the event described in the log message. In some embodiments, the log message may not be associated with a particular process tag, and the system(s) 120 or the device 101 may store data associating the log message with an “unseen” process tag.

The system(s) 120 or the device 101 may select (132) a ML model (from multiple ML models) associated with a first process tag. The system(s) 120 or the device 101 may include multiple ML models configured to process log messages, where each ML model may be configured to process log messages associated with a particular process tag. One of the ML models may be configured to process log messages associated with the “unseen” process tag. In some embodiments, each of the ML models may be a random forest model (or other type of models for density estimation) configured to process the log message to determine whether it is potentially anomalous.

The system(s) 120 or the device 101 may then process (134) a first log message associated with the first process tag using the selected ML model to determine model data. The model data may represent data generated during processing of the first log message by the selected ML model. In the case the ML model is a random forest, the model data may represent one or more traversal paths taken in processing the first log message. The model data may be a density estimate determined by processing the first log message using the selected ML model. In some embodiments, the selected ML model may process feature data corresponding to the first log message to determine the density estimate.

The system(s) 120 or the device 101 may determine (136) that the first log message is anomalous based at least in part on the model data. The system(s) 120 or the device 101 may determine a first score representing the first log message is potentially anomalous, where the first score may be based on the density estimate and a relative frequency of how often the first process tag appears in the log messages (processed in step 130). The system(s) 120 or the device 101 may then process the first log message, based on it being potentially anomalous, to determine make a final determination that the first log message is anomalous. The system(s) 120 or the device 101 may process the first log message, using another ML model (e.g., a Naïve Bayes model), with respect to log messages indicated by the user 10 as being anomalous. Based on processing the first log message using the Naïve Bayes model, the system(s) 120 or the device 101 may generate a second score for the first log message indicating that it is anomalous. Further details related to operations 130, 132, 134 and 136 are described below in connection with the context component 210 of FIG. 2.

The system(s) 120 or the device 101 may process (138) the model data (determined in step 134) to determine an explanation as to why the first log message is anomalous. The system(s) 120 or the device 101 may analyze model data representing a traversal path taken in the random forest model while processing the first log message to determine the explanation. Further details related to operation 138 are described below in connection with the explanation component 220 of FIG. 2. In some embodiments, the explanation may be stored as text data. The system(s) 120 or the device 101 may store data representing the explanation and associated with the first log message.

The system(s) 120 or the device 101 may generate (140) output data using the explanation. The output data may include a visual element to be displayed at the device 101 to the user 10 indicating to the user 10 that the first log message is anomalous. The output data may further include text data representing the explanation, and the text data may be displayed at the device 101 as corresponding to the first log message.

In this manner, an anomaly detection system may use ML models that are particularly configured to identify anomalous log messages of a particular process tag/type. The system may also generate an explanation for the why the log message is anomalous, and the explanation may be presented to the user for review.

In some embodiments, the steps illustrated in FIG. 1 may be encoded as instructions on a non-transitory computer-readable medium, which may be executed by a processor of the device 101 or by a processor of the system(s) 120.

FIG. 2 is a conceptual diagram illustrating components of an anomaly detection system 200 according to embodiments of the present disclosure. One or more of the components of the anomaly detection system 200 may be included in the system(s) 120. One or more of the operations described in connection with FIG. 1 may be performed by one or more components of the anomaly detection system 200. It should be understood that the anomaly detection system 200 may include fewer or more components than illustrated in FIG. 2.

In an example embodiment, the anomaly detection system 200 may include a context component 210, one or more ML models 215, an explanation component 220, a user feedback 230, and a scoring component 240. The anomaly detection system 200 may receive input log messages 205 for processing and may output annotated log messages 250. The input log messages 205 may be one or more messages of a single machine-generated log that is generated by a single device/system. The annotated log messages 250 may be the input log messages 205 including text annotations and/or visual annotations, where the annotations indicate whether a log message includes an anomaly or appears to be unusual. The annotations may also include an explanation for why the system 200 determined the log message to include an anomaly. The annotated log messages 250 may include data that enables the device 101 to display the log messages and annotations via a user interface.

Machine-generated log messages are one of the most data-rich sources of information regarding system health. The machine-generated log, referred to herein, may be information logged by a syslog utility and may be referred to as syslogs or syslog messages. Unusual log messages can be indicators of serious problems, which may require human intervention. However, the logs can be long and disorganized, and going through them line by line by hand is time-consuming and error prone. The log messages are data-rich, with content as well as structure. An example log message contains a timestamp, a prompt indicating the machine name, and the raw message content. This message may range from a single token up to about 100 characters. The message content may contain natural language text, numeric data, or a combination of the two. The natural language vocabulary of the log is more limited than a human's vocabulary, leading to significant structure in the log messages. Textual data can include information about running processes and their progress, while numeric data may contain memory addresses, version information, etc.

Rather than drawing on natural language processing techniques that require large corpora and assume a large vocabulary, the anomaly detections system 200 may cast the problem of analyzing the textual component of the log messages as a graph analysis question. This allows exploitation of the structure in the text of the log messages. In some embodiments, the anomaly detection system 200 may employ graph clustering techniques to analyze the text data of the machine-generated log.

In processing a machine-generated log, the anomaly detection system 200 may process multiple input log messages 205 of a single machine-generated log, where the single machine-generated log may correspond to a particular system and may include messages generated during a particular time period (e.g., 24 hours). In some embodiments, the anomaly detection system 200 may process an input log message 205 when (or substantially soon after) it is generated by a system. In other embodiments, the anomaly detection system 200 may process all the messages generated within a particular time period (e.g., using a batch processing technique).

The context component 210 may process the machine-generated log and extract features corresponding to the messages in the log. These features may represent the text and numerical values included in the message.

In some embodiments, the text data of the machine-generated log may be processed and organized in a graph using statistical relational learning. The context component 210 may create a node (e.g., a parent node) in the graph for each message in the log, and may build a node (e.g., a child node) from the parent node for each token represented in the messages. A token may correspond to a word in the message. For example, for an example message, a first token and a first child node may be “kernel”, a second token and a second child node may be “system”, etc. The context component 210 may then build a node (another child node) from the parent node for each numeric value represented in the message. In some embodiments, the parent node may be associated with the raw data of the message. The nodes may be connected with edges based on where the token or the numerical value appear in the message. For example, nodes representing adjacent tokens may be connected with an edge, and the nodes representing an adjacent token and numerical value may be connected with another edge. The edge may be annotated with a count of how many times the token and/or the numerical value occur adjacent to each other. The context component 210 may add an edge between a first parent node of a first message and a first child node of a first token to represent that the first message includes the first token, and another edge between the first parent node and a second child node of a first numerical value to represent that the first message includes the first numerical value. Thus, the context component 210 may generate an undirected weighted graph corresponding to the tokens and the numerical values appearing in the input log messages 205 of the machine-generated log.

The context component 210, in some embodiments, may use the graph to determine clusters (groups) of messages based on the textual tokens. The context component 210 may use a graph clustering technique and/or a community detection technique to determine the groups of messages. A community may be subgraph of the graph. Running a clustering algorithm on the subgraph of textual tokens may provide clear, interpretable clusters. Table 1 shows example clusters. Statistically related terms/tokens may appear in the same cluster based on the terms/tokens. Additionally, the clustering algorithm may output a manageable number of clusters. Casting the problem as clustering allows the anomaly detection system 200 to take advantage of the content of the messages as well as the structure of the messages.

TABLE 1
Example clusters generated based on textual
tokens in a machine-generated log

| Cluster No. | Top Tokens |
|---|---|
| C1 | activat, work, stage, device, own, woke |
| C2 | read, process, made, successful, main |
| C3 | call, trace |
| C4 | fail, no, sink-inputc, create, initial |
| C5 | all, rights, page, send, ahci, uid, cpu |
| C6 | subsequent, snd_pcm_avail, another |

For each message, the context component 210 may extract all decimal and hexadecimal numbers. Because the format of each message may differ, the representation of numbers, and the count of numbers in the messages also differ. To handle this inhomogeneity, the context component 210 may use relational features, on a message-basis, to describe the numeric data in each message. Instead of including the raw numeric values in the features for each message, the context component 210 may include the count of the numeric values in the message, the average of the numerical values, and the standard deviation of the numerical value. This makes the features agnostic to the particular formatting of the messages. The count of the numeric values in the message may represent the total number of decimal and hexadecimal values in the message. The average of the numerical values, in some embodiments, may be an average of the decimal and hexadecimal values, as illustrated in Table 3. The standard deviation may be calculated based on the decimal and hexadecimal values in the message, as illustrated in Table 3.

Table 2 illustrates some example truncated log messages. Table 3 illustrates example numerical features extracted from the example log messages of Table 2.

TABLE 2
Example (truncated) messages in a machine-generated log.

| Line ID | Message Content |
|---|---|
| 1 | kernel: 00000000 c0ab9bc0 00000286 |
| 2 | kernel: sys_clock_gettime + 0x98/0xb0 |
| 3 | started daemon version 0.96 |
| 4 | kernel: Call Trace: |
| 5 | Stage 5 of 5 (IP Configure) complete. |

TABLE 3
Example numerical features extracted from the
example messages illustrated in Table 2.

| Line ID | Number Count | Average | Standard Deviation |
|---|---|---|---|
| 1 | 3 | 1,077,490,882 | 1,866,268,393 |
| 2 | 2 | 164 | 16,971 |
| 3 | 1 | 0.96 | 0 |
| 4 | 0 | 0 | 0 |
| 5 | 2 | 5 | 0 |

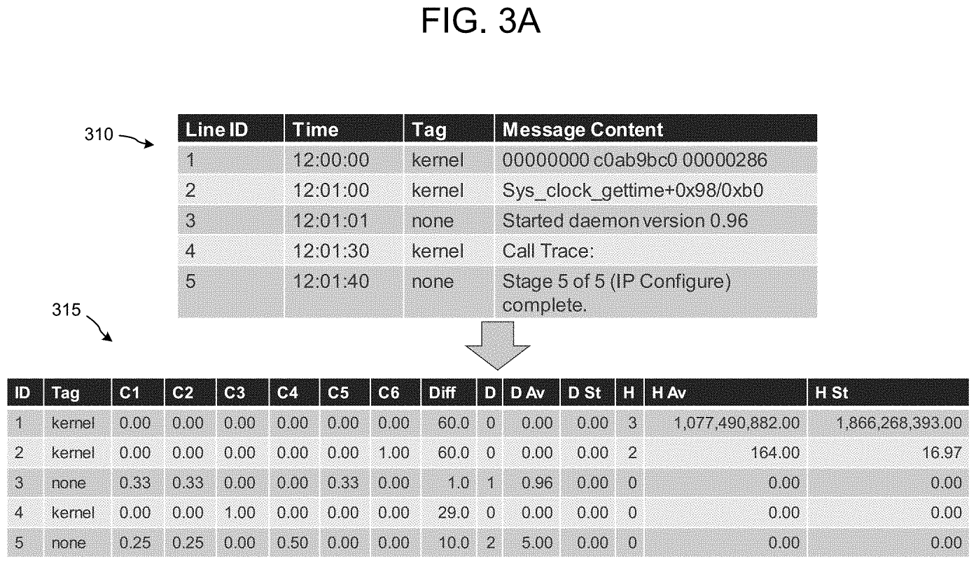

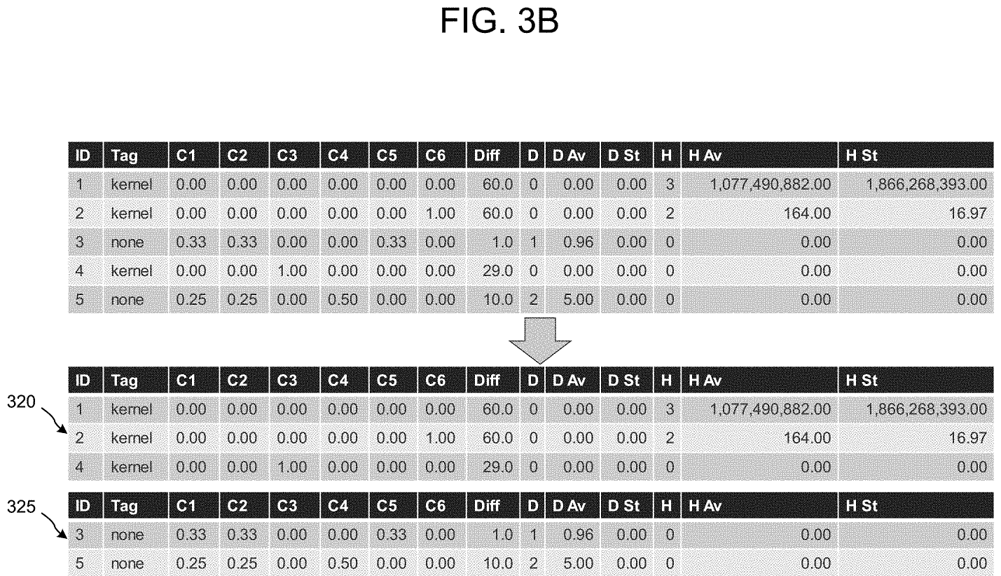

In some embodiments, the features may include a count of the decimal values in the message, shown as column “D” in FIG. 3A, a decimal value average based on the average of the decimal values in the message, shown as column “D Av” in FIG. 3A, and a standard deviation based on the decimal values in the message, shown as column “D St” in FIG. 3A. The features may also include a count of the hexadecimal values in the message, shown as column “H” in FIG. 3A, a hexadecimal value average based on the average of the hexadecimal values in the message, shown as column “H Av” in FIG. 3A, and a standard deviation based on the hexadecimal values in the message, shown as column “H St” in FIG. 3A. The features may also include a difference in time, shown as column “Diff” in FIG. 3A, when the message is received compared to a previous (or subsequent message, based on system configuration). For example, the difference in time for a second message may be based on a difference in the timestamp of a first message received prior to the second message. The difference in time may be represented in seconds (or minutes or hours) between when messages are received.

The context component 210 may store features/feature data corresponding to each input log message 205, where the feature data may include an indication of whether a particular cluster of tokens is represented in the input log message 205. The feature data may further include the determined numerical features. Example feature data 315 for example input log messages are illustrated in FIG. 3A. The top portion of the FIG. 3A illustrates example messages, and the bottom portion of the FIG. 3A illustrates the corresponding feature data 315 for each message.

After extracting the clusters on the textual data, and the relational features on the numeric data, the two sets are combined to generate feature data for a message. The feature data may also include a keyword count based on the textual tokens included in the message. For each message, the context component 210 may calculate the percentage of its textual tokens contained in each cluster. The example clusters may be ones illustrated in Table 1 above. FIG. 3A illustrates the calculated percentage in columns “C1”, “C2”, “C3”, “C4”, “C5” and “C6” corresponding to the six clusters. The message is assigned to the cluster with the maximum percentage of its tokens.

The context component 210 may also identify a process tag associated with each of the input log message 205. In some cases, the input log message 205 may include a process tag, as illustrated in column “tag” of FIG. 3A (e.g., “kernel”). In some cases, the input log message 205 may not include a process tag or the process tag may be “none” as illustrated in FIG. 3A. In other embodiments, the context component 210 may process the text description of the event to determine a process tag for the message, for example, using natural language processing, root word matching, semantic similarity techniques, or using other techniques. The process tag may be included in the feature data corresponding to the input log message 205. Exemplary process tags may include, but are not limited to, kernel, memory dump, information, warning, error, application, security, acpi (advanced configuration and power interface), automount, sshd, xinetd, kdump, and others.

Using the feature data corresponding to the input log message 205, the context component 210 may group messages based on the associated process tag, as illustrated in the bottom portion of FIG. 3B. The input log messages 205 corresponding to the “kernel” process tag are included in a first group of messages 320, and the input log messages 205 corresponding to the “none” process tag are included in a second group of messages 325. In other embodiments, the messages may be grouped based on other features based on system configuration.

The context component 210 may select a ML model from the ML models 215 for the process tag to process the grouped input log messages 205. For example, to process the first group of messages 320, the context component 210 may select a first ML model, and to process the second group of messages 325, the context component 210 may select a second ML model. Each of the ML model(s) 215 may be a random forest model. In other embodiments, each of the ML model(s) 215 may be a different type of tree-based model, a classifier, a neural-network based model, a probabilistic graph, a regression model, other types of ML models, or a combination of different types of ML models. In some embodiments, one or more of the ML models 215 may be a different type of ML model than the other of the ML models 215.

During training of the ML models 215, training data may be divided into non-overlapping datasets, one dataset per process tag. Each dataset may include actual log messages generated by the system(s) 120, the device 101, and/or other systems and devices. The dataset may also include synthetic log messages that may be created manually by a user. The dataset may include feature data corresponding to each log message, and a label/annotation indicating whether the log message is anomalous or not.

In some embodiments, the context component 210 may select a ML model(s) 215 based on features other than a process tag corresponding to the input log message 205, such as, based on the number on numerical values in the message, the number of tokens in the message, the average the numerical values in the message, etc. As such, a ML model 215 may be configured to process log messages corresponding to a certain type of feature.

After identifying the process tag associated with the input log message 205, the context component 210 may select the ML model 215 corresponding to the process tag and provide the input log message 205 and the corresponding feature data (e.g., data 315) to the selected ML model 215 for further processing. The ML model 215 may perform density estimation. Density estimation may refer to construction of an estimate, based on observed data, of an unobservable underlying probability density function. Density estimation may refer to a non-parametric way to estimate the probability density function of a random variable. Density estimation is a fundamental data smoothing problem where inferences about the population are made, based on a finite data sample. The density estimator may involve use of a random forest model to compute the density estimate. A random forest model may be an ensemble learning method for classification, regression and other tasks that operate by constructing a multitude of decision trees at training time, and outputting the proportion of trees which output each class. Using the selected ML model 215, the context component 210 may conduct a kernel density estimate to create a fine-grained anomaly detector that not only detects that a message is potentially anomalous, but that it is also potentially anomalous for the type of message it is. The context component 210 estimates the density of each message based on its grouping, and ranks the messages based on this estimate, with the least dense messages ranked as most anomalous.

In some embodiments, the context component 210 may use a combination of the density estimation, determined by the ML model 215, and a relative frequency of each process tag (or other feature) associated with the input log message 205 to determine a first score corresponding to the input log message 205. The relative frequency of the process tag may represent how often the process tag appears in the input log messages 205 of the machine-generated log (being analyzed) compared to other process tags appearing the input log messages 205. The relative frequency may be a ratio of the messages corresponding to the process tag and the messages corresponding to other process tags (e.g., relative frequency=(number of messages with “kernel”)/(total number of messages−number of messages with “kernel”)). The relative frequency may be a ratio of the messages corresponding to the process tag and the total number of messages (e.g., relative frequency=(number of messages with “kernel”)/(total number of messages”)).

The first score may indicate whether the input log message 205 is potentially anomalous or not. The first score may be determined using a linear combination of the density estimate and the process tag frequency.

During runtime, if the context component 210 encounters a process tag that it does not recognize or has not been configured to process, then the context component 210 may assign a default first score (potentially anomalous score) and may associate the explanation “unseen” with the input log message 205.

The relevancy scoring component 240 may include software and/or hardware components that are configured to generate a final anomalous score (e.g., a second score) corresponding to the input log message 205, where the second score may represent a final determination as to whether the log message is anomalous. The second score may be a number between 0 and 1, and may indicate, in some embodiments, a likelihood of the log message including an anomaly. The second score may, in some embodiments, indicate a confidence level of the relevancy scoring component 240 that a log message includes an anomaly.

Not all messages that include anomalous-looking (unusual looking) data, as determined by the ML model 215, may be of interest to the user 10 as the anomalous-looking data may be benign. The relevancy scoring component 240 may be configured to determine which of the potentially anomalous messages of the input log messages 205 should be presented to the user 10 as anomalous. To do so, the relevancy scoring component 240 may take into consideration what the user 10 may find of particular interest. To this end, the relevancy scoring component 240 may be configured using inputs provided the user 10 in the past, where the inputs may indicate whether a particular log message was anomalous or not for the user 10. The relevancy scoring component 240 may implement one or more ML models to determine the second score. In an example embodiment, the ML model may be a Naïve Bayes model. In other embodiments, the machine learning model may be other network-based machine learning models or other types of machine learning models.

The relevancy scoring component 240 may receive the input log message 205 that the ML model 215 determined as being potentially anomalous, and the feature data corresponding to the input log message 205. In some embodiments, the relevancy scoring component 240 may also receive the first score corresponding to the input log message 205. In some embodiments, the context component 210 may provide the input log message 205 if the first score satisfies a threshold condition.

The ML model of the relevancy scoring component 240 may be trained using a training dataset including log messages, where a first portion of the log messages may be labeled/annotated as being of interest (for the user 10) and a second portion of the log messages may be labeled/annotated as not being of interest. The log messages in the training dataset may be represented as text data. The ML model of the relevancy scoring component 240 may be configured to perform text-based classification, that is, process the input log message 205 with respect to the training dataset to determine whether the input log message 205 to the first class of log messages of interest or the second class of log messages that are not of interest. The ML model may make this determination based on the tokens/words and numerical values included the input log message 205, the probability of the tokens/words and numerical values appearing in the first class or the second class of log messages. The ML model may output a probability/second score indicating whether the input log message 205 belongs to the first class.

If the second score satisfies a threshold condition, then the corresponding input log message 205 may be included in the annotated log messages 250. Based on the second score, in some cases, a log message may be considered as irrelevant, where the log message may be determined to be statistically anomalous with a low density estimate (generated by the context component 210), but not actually be informative/relevant to the user 10.

In some embodiments, the anomaly detection system 200 may be configured to generate a final anomalous/third score that is associated with the annotated log messages 250. The third score may be generated using a linear combination (with configurable coefficients) of the first (potentially anomalous) score generated by the context component 210 (which includes the density estimate outputted by the process tag specific ML model 215 and the tag frequency) and the second score generated by the relevancy scoring component 240. In some embodiments, the third score for each message in the annotated log messages 250 may be outputted to the user 10 via a user interface.

The user feedback component 230 may include software and/or hardware components that are configured to receive and process user input 206. The user input 206 may be provided by the user 10 via the device 101. The user input 206 may represent user feedback regarding true positives, true negatives, false positives, and false negatives with respect to the annotated log messages 250 generated by the anomaly detection system 200. The user 10 may review the annotated log messages 250 and may provide the user input 206. In some embodiments, the user 10 may flag a log message as “interesting” or “benign.” The user feedback component 230 may store the log messages and their associated user-provided labels (e.g., user input 206). When the anomaly detection system 200 retrains, it may use the labeled data in addition to the previous training data to configure a new version or update a machine learning model (e.g., a Naïve Bayes classifier model) implemented by the relevancy scoring component 240. In this manner, over time, the anomaly detection system 200 can adapt more specifically to what a particular user is looking for. For example, a human operator who is a network specialist can expect over time to start getting alerts from the system 100 that are tailored more to network problems.

The user feedback component 230 may collect and store feedback from multiple different users of the system within a particular organization. In some cases, the user feedback component 230 may store the feedback as associated with a particular user 10 of the organization. In other cases, the user feedback component 230 may store the feedback as associated with the organization, without indicating a particular user that provided it.

In some embodiments, one or more components of the anomaly detection system 200 may be retrained/updated based on the user input 206. In some cases, the components may be updated on a per-user basis, and the system may have different instances of the components of the system 200 associated with different users. In other cases, the components may be updated for an organization using feedback from all the users of the organization.

The explanation component 220 may include software and/or hardware components that are configured to generate an explanation describing why the anomaly detection system 200 detected the input log message 205 as anomalous. The explanation component 220 may only be invoked/executed, in some embodiments, if the first score and/or the second score satisfy a threshold condition, causing the input log message 205 to be included in the annotated log messages 250.

The explanation component 220 may be configured to generate explanations using the traversal paths or processing paths of the machine learning model(s) implemented by the context component 210. When a log message 205 is determined to have an anomaly (based on a score(s) or other data outputted by the context component 210), the log message 205, data related to processing of the log message 205 by the context component 210 and other information may be provided to the explanation component 220. The explanation component 220 may analyze the path traversed by the context component 210 to determine that the log message includes an anomaly. The context component 210 may traverse a decision tree and the traversed path, in some embodiments, may include a directed path from an initial node to a final node. In other embodiments employing other types of machine learning models, such as network-based models, the traversed path may be the path of activation through the network.

The explanation component 220 may be configured to explore each decision tree in the random forest of the ML model 215 which classified the particular data point as anomalous. In this way, the user 10 can explore the potential reasons behind the anomaly. The explanation component 220 may accomplish this exploration by first identifying the set of decision trees within the random forest that classified the given data point as anomalous. For each of these trees, the explanation component 220 finds the end leaf corresponding to the given data point. The explanation component 220 may begin to trace/traverse back up the decision tree, taking note of each decision node where a difference in a feature value(s) would have resulted in a classification as non-anomalous, thus, investigating possible counterfactuals. The explanation component 220 may employ a heuristic algorithm, which weighs the cost of changing multiple feature values with the length of the changed path in the tree, to determine which decision nodes and/or feature values should be included in the explanation. At each decision node where this is the case, the explanation component 220 stores/makes note of the relevant decision rule. The explanation component 220 may collect each relevant decision rule it finds in each decision tree, any may condense them into as few rules as possible. The condensed rules may be presented to the user 10 as a list of rules that caused the anomaly detection system 200 to classify the given message as anomalous. The explanation component 220 may present the user 10 with a list of features and thresholds that, had the feature value been different with respect to the threshold value, the point would have been considered normal.

For example, if the explanation component 220 finds that three trees in the random forest classify a given data point as anomalous, the relevant rules might be: “Decimal Count<3” indicating an anomalous message, “Decimal average>2000” indicating an anomalous message, and “Hexadecimal average<=35” indicating an anomalous message. The explanation component 220 may employ an algorithm that searches through these potential new rules and consolidates any rules regarding the same feature, with the same inequality direction, into a single rule. If a feature always appears in the potential new rules as less than some threshold, the potential rule suggested to the user 10 takes the minimum of all thresholds found, and similarly if the feature is always greater than some threshold. In this way, given the example rules just mentioned, the method would suggest the rules “Decimal average>2000 and Hexadecimal average<=35” as the reasons for the anomalous message to the user 10.

In some embodiments, the explanation component 220 may use a description of the anomalous data instance's path through each decision tree, balancing emphasis on number of features (represented by nodes) changed and feature importance. Within each decision tree and for the given data instance, the explanation component 220 may evaluate each possible path in the tree that leads to a classification of the log message being “normal.” When processing a log message, the random forest may traverse different portions of the forest to evaluate each feature (e.g., token cluster, decimal average, decimal count, hexadecimal average, hexadecimal count, etc.) corresponding to the message. For each of these traversed paths, the explanation component 220 may calculate the total number of features (e.g., features 315 of FIG. 3A) in the message that would have to be altered in order to take the path, as well as the depth in the tree, of the relevant “normal” node. For each potential “normal” path, the explanation component 220 may calculate a score using a heuristic technique, for example, a linear combination of the number of features changed and the depth in the decision tree. The coefficients of the linear combination may be configurable based on user needs. Then, for each tree, the explanation component 220 may select the path with the minimum heuristic score. The heuristic score may be calculated based on the depth of the “normal” leaf being reached in the tree and the number of features that need to be altered to reach that leaf. For each of these selected paths, the explanation component 220 may record the feature threshold (e.g., Decimal count>3) at each decision node which the anomalous data instance does not already pass through. The explanation component 220 then may aggregate the features and feature thresholds across the random forest (or entire decision tree). In some embodiments, the explanation component 220 may limit the number of explanations presented to the user 10, for example, such that the number explanations equals to twice the number of features in the log message.

In some embodiments, the explanation component 220 may find the fewest number of changes that would have to be made to the anomalous log message in order for it to appear normal, rank those changes by the feature's importance and the number of times the features appear across the decision tree as predicting an anomaly, and report the top 5 changes as explanations.

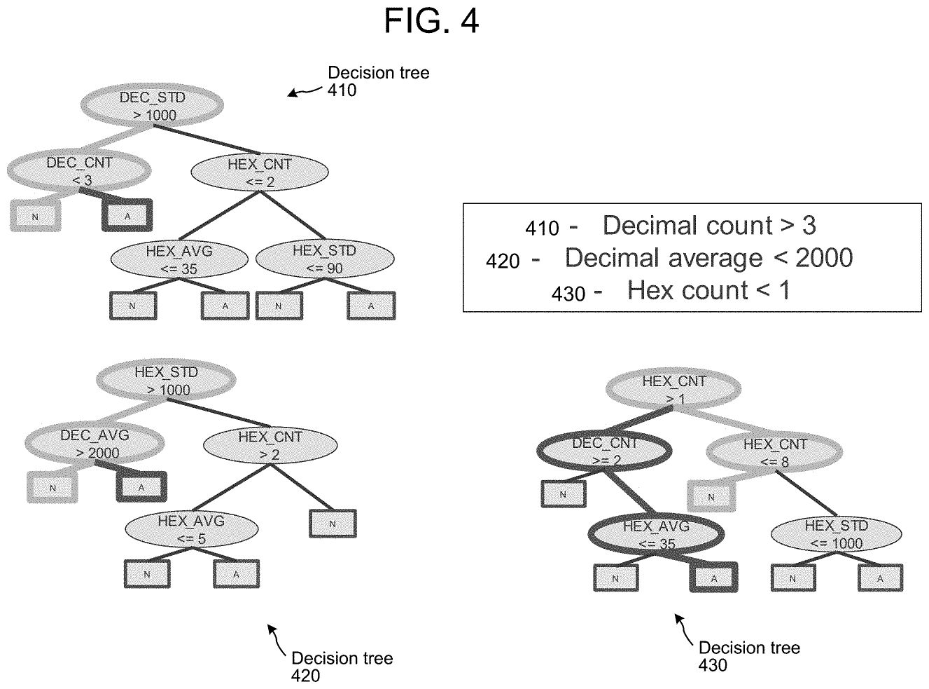

FIG. 4 illustrates three exemplary trees 410, 420 and 430 of the random forest (e.g., ML model 215) that may be traversed to determine if a log message is anomalous. As illustrated in decision tree 410, the initial decision node may be DEC_STD>1000, and the final decision nodes may be N (for normal) or A (for anomalous). The explanation component 220 may perform the steps described above to determine that the explanation for the anomalous log message processed using decision tree 410 is “Decimal count>3.” The explanation component 220 may perform the steps described above to determine that the explanation for the anomalous log message processed using decision tree 420 is “Decimal average<2000.” The explanation component 220 may perform the steps described above to determine that the explanation for the anomalous log message processed using decision tree 430 is “Hex count<1.”

In an example embodiment, the explanation component 220 may identify the final decision node of the machine learning model that a log message identified as anomalous passed through, and record the feature and threshold of that node. The recorded features and thresholds may be used to determine the explanation associated with the annotated log message.

In some embodiments, the anomaly detection system 200 may also use community detection techniques. The log messages 205 may be considered to have community structure if the log messages can be grouped into nodes corresponding to topics. Community detection, as used herein, may refer to computer processing to identify groupings of log messages based on one or more topics represented in the log messages. The anomaly detection system 200 may also use statistical relational learning that uses, for example, first-order logic to describe relational properties, and that draws upon probabilistic graphical models (e.g., Bayesian networks or Markov networks) to model uncertainty. The anomaly detection system 200 may also use natural language processing, which refers to a field of computer science and artificial intelligence concerned with processing and analyzing natural language data (e.g., text data including natural language text).

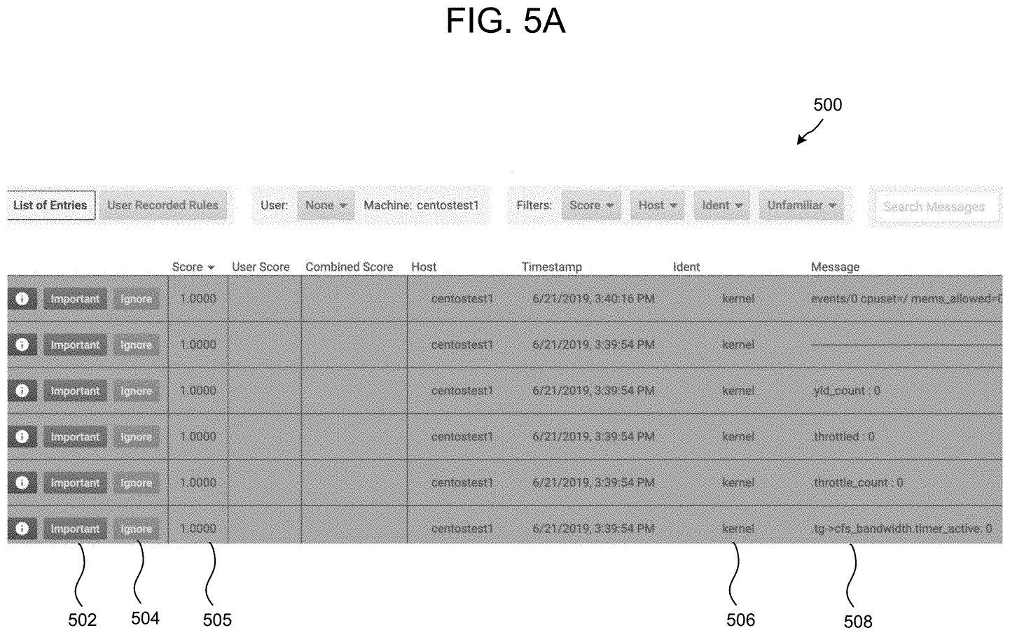

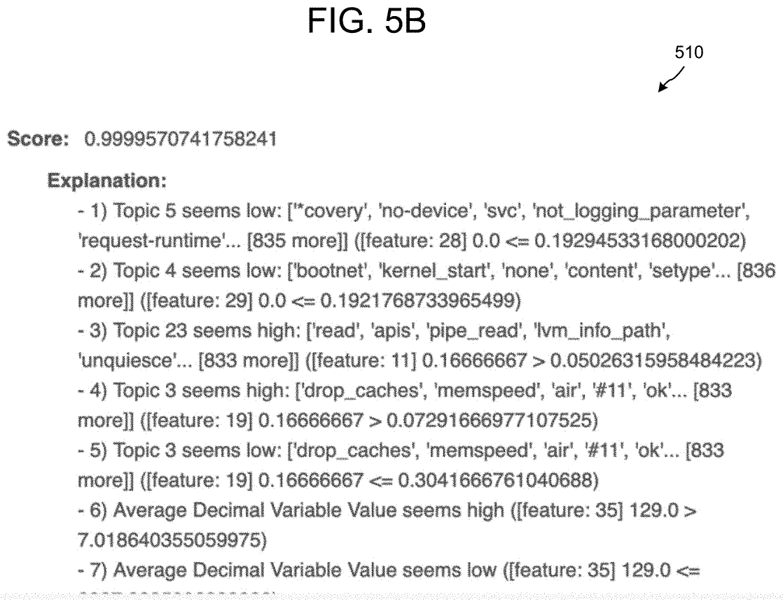

FIG. 5A illustrates an example user interface 500 displaying annotated log messages 250 that were found to anomalous by the anomaly detection system described herein. The user interface 500 may include buttons, such as buttons 502 and 504, using which the user 10 may provide feedback on whether the indicated log message is of interest to the user 10 or not of interest. The information shown in column 505 may be the second score (or the first score or another score) determined by the anomaly detections system as described above. The information shown in column 506 corresponds to a process tag of the log message. The information shown in column 508 corresponds to the text included in the log message.

FIG. 5B illustrates an example user interface 510 displaying explanations for an anomalous log message. The user 10 may click on an anomalous log message, causing a score (e.g., the second score) to be displayed representing a confidence level of the system in determining that the log message is anomalous. The user interface 510 also displays one or more explanations as to why the log message is determined to be anomalous.

In some embodiments, when a user selects a log message or hovers over a log message, a dialog box or pop-up window may be displayed including an explanation for why the system detected the log message as anomalous, where the explanation may be generated as described with respect to the explanation component 220. In some embodiments, to provide the user 10 with useful context, the anomaly detection system 200 may report an event block containing the anomalous message, where the event block may include some previously and some subsequently received messages with respect to the anomalous message.

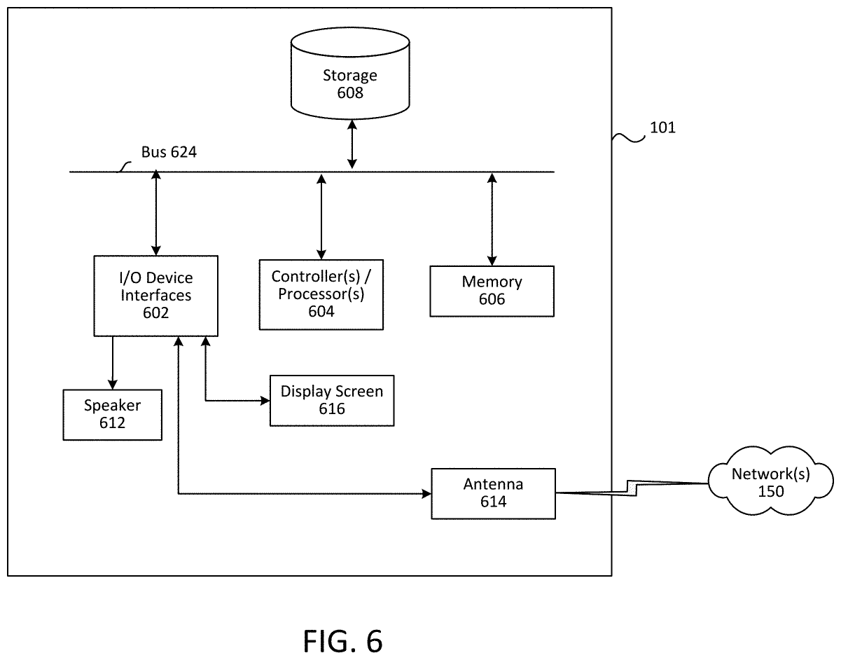

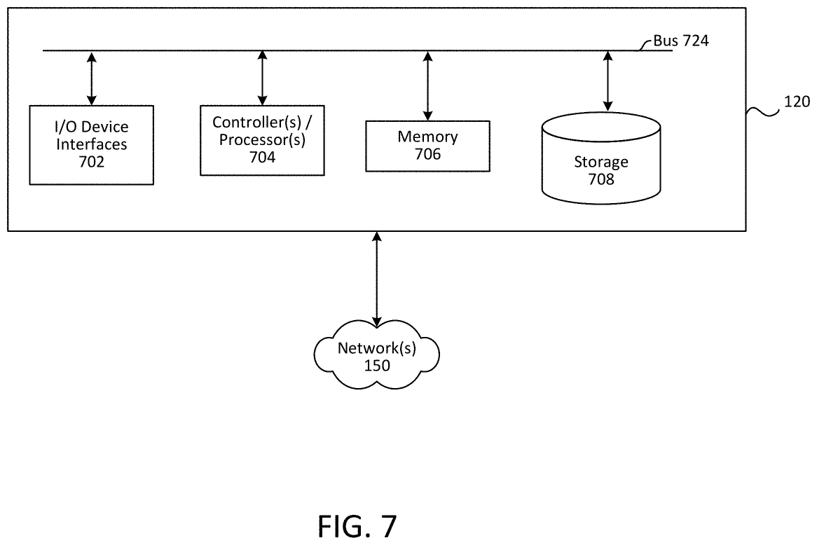

FIG. 6 is a block diagram conceptually illustrating a device 101 that may be used with the system 100. The device 101 may generate the machine-generated logs and/or may be used to receive/view the annotated machine-generated logs. The system 100 may include multiple devices 101 to form a network of devices or a HPC center. FIG. 7 is a block diagram conceptually illustrating example components of a remote device, such as the system 120, which may be used to analyze/process the machine-generated logs to detect anomalies. A system 120 may include one or more servers. A “server” as used herein may refer to a traditional server as understood in a server/client computing structure but may also refer to a number of different computing components that may assist with the operations discussed herein. For example, a server may include one or more physical computing components (such as a rack server) that are connected to other devices/components either physically and/or over a network and is capable of performing computing operations. A server may also include one or more virtual machines that emulates a computer system and is run on one or across multiple devices. A server may also include other combinations of hardware, software, firmware, or the like to perform operations discussed herein. The server(s) may be configured to operate using one or more of a client-server model, a computer bureau model, grid computing techniques, fog computing techniques, mainframe techniques, utility computing techniques, a peer-to-peer model, sandbox techniques, or other computing techniques. The system 100 may include multiple system(s) 120 to perform various actions, and each these system(s) 120 may include computer-readable and computer-executable instructions that reside on the respective system 120 as discussed further below.

Each of these devices 101 and system 120 may include one or more controllers/processors (604/704), which may each include a central processing unit (CPU) for processing data and computer-readable instructions, and a memory (606/706) for storing data and instructions of the respective device. The memories (606/706) may individually include volatile random access memory (RAM), non-volatile read only memory (ROM), non-volatile magnetoresistive memory (MRAM), and/or other types of memory. Each device 101/system 120 may also include a data storage component (608/708) for storing data and controller/processor-executable instructions. Each data storage component (608/708) may individually include one or more non-volatile storage types such as magnetic storage, optical storage, solid-state storage, etc. Each device 101/system 120 may also be connected to removable or external non-volatile memory and/or storage (such as a removable memory card, memory key drive, networked storage, etc.) through respective input/output device interfaces (602/702).

Computer instructions for operating each device 101/system 120 and its various components may be executed by the respective device's controller(s)/processor(s) (604/704), using the memory (606/706) as temporary “working” storage at runtime. A device's computer instructions may be stored in a non-transitory manner in non-volatile memory (606/706), storage (608/708), or an external device(s). Alternatively, some or all of the executable instructions may be embedded in hardware or firmware on the respective device in addition to or instead of software. At least one non-transitory, computer-readable medium may be encoded with instructions which, when executed by at least one processor(s) (604/704) may cause the device 101/the system 120 to perform one or more functionalities described herein in relation to the anomaly detection system.

Each device 101/system 120 includes input/output device interfaces (602/702). A variety of components may be connected through the input/output device interfaces (602/702), as discussed further below. Additionally, each device 101/system 120 may include an address/data bus (624/724) for conveying data among components of the respective device. Each component within a device 101/system 120 may also be directly connected to other components in addition to (or instead of) being connected to other components across the bus (624/724).

Referring to FIG. 6, the device 101 may include input/output device interfaces 602 that connect to a variety of components such as an audio output component such as a speaker 612, or other component capable of outputting audio. The device 101 may also include an audio capture component. The device 101 may additionally include a display screen 616 for displaying content. The device 101 may further include a camera.

Via antenna(s) 614, the input/output device interfaces 602 may connect to one or more networks 150 via a wireless local area network (WLAN) (such as WiFi) radio, Bluetooth, and/or wireless network radio, such as a radio capable of communication with a wireless communication network such as a Long Term Evolution (LTE) network, WiMAX network, 3G network, 4G network, 5G network, etc. A wired connection such as Ethernet may also be supported. Through the network(s) 150, the system may be distributed across a networked environment. The I/O device interface (602/702) may also include communication components that allow data to be exchanged between devices such as different physical servers in a collection of servers or other components.

The components of the device 101 or the system 120 may include their own dedicated processors, memory, and/or storage. Alternatively, one or more of the components of the device 101 or the system 120 may utilize the I/O interfaces (602/702), processor(s) (604/704), memory (606/706), and/or storage (608/708) of the device 101 or the system 120, respectively.

As noted above, multiple devices may be employed in a single system. In such a multi-device system, each of the devices may include different components for performing different aspects of the system's processing. The multiple devices may include overlapping components. The components of the device 101 and the system 120, as described herein, are illustrative, and may be located as a stand-alone device or may be included, in whole or in part, as a component of a larger device or system.

The concepts disclosed herein may be applied within a number of different devices and computer systems, including, for example, general-purpose computing systems, and distributed computing environments.

The above aspects of the present disclosure are meant to be illustrative. They were chosen to explain the principles and application of the disclosure and are not intended to be exhaustive or to limit the disclosure. Many modifications and variations of the disclosed aspects may be apparent to those of skill in the art. Persons having ordinary skill in the field of computers and speech processing should recognize that components and process steps described herein may be interchangeable with other components or steps, or combinations of components or steps, and still achieve the benefits and advantages of the present disclosure. Moreover, it should be apparent to one skilled in the art, that the disclosure may be practiced without some or all of the specific details and steps disclosed herein.

Aspects of the disclosed system may be implemented as a computer method or as an article of manufacture such as a memory device or non-transitory computer readable storage medium. The computer readable storage medium may be readable by a computer and may comprise instructions for causing a computer or other device to perform processes described in the present disclosure. The computer readable storage medium may be implemented by a volatile computer memory, non-volatile computer memory, hard drive, solid-state memory, flash drive, removable disk, and/or other media. In addition, components of system may be implemented as in firmware or hardware.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements, and/or steps are in any way required for one or more embodiments or that one or more embodiments necessarily include logic for deciding, with or without other input or prompting, whether these features, elements, and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, Z,” unless specifically stated otherwise, is understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

As used in this disclosure, the term “a” or “one” may include one or more items unless specifically stated otherwise. Further, the phrase “based on” is intended to mean “based at least in part on” unless specifically stated otherwise.

What is claimed is:

1. A computer-implemented method for detecting an anomalous message in a machine-generated log, the method comprising:
receiving a plurality of log messages of the machine-generated log, the plurality of log messages including at least a first log message and a second log message;
determining a first process tag associated with the first log message and a second process tag associated with the second log message;
selecting, from a plurality of machine learning models, a first machine learning model corresponding to the first process tag;
processing the first log message using the first machine learning model to determine model data;
determining, using the model data, that the first log message is potentially anomalous;
determining, using the model data, an explanation for determining that the first log message is potentially anomalous; and
generating output data including the explanation and an indicator that the first log message is anomalous.

2. The computer-implemented method of claim 1, further comprising:
processing the first log message using the first machine learning model to determine a first score, the first score representing a likelihood that the first log message is potentially anomalous,
wherein the output data is further generated based on the first score satisfying a condition.

3. The computer-implemented method of claim 2, further comprising:
processing the first log message using a second machine learning model to determine a second score corresponding to the first log message, the second score representing the first log message is of interest to a user,
wherein the second machine learning model is configured using inputs received from the user, the inputs indicating a first set of log messages of interest to the user and a second set of log message of non-interest to the user.

4. The computer-implemented method of claim 3, further comprising:
determining a third score, based at least in part on the first score and the second score, corresponding to the first log message; and
determining that the third score satisfies a condition,
wherein generating the output data is further based on the third score satisfying a condition.

5. The computer-implemented method of claim 1, further comprising:
determining feature data corresponding to the first log message,
wherein the first machine learning model is a random forest model, and
wherein processing the first log message using the first machine learning model comprises processing the feature data using the random forest model.

6. The computer-implemented method of claim 5, wherein the model data corresponds to a traversal path taken in processing the feature data using the random forest model, and
wherein the explanation is determined based at least in part on the traversal path and a decision threshold corresponding to at least one feature included in the feature data.

7. The computer-implemented method of claim 5, wherein the feature data includes a first feature representing a word in the first log message and a second feature representing a numerical value in the first log message.

8. The computer-implemented method of claim 1, further comprising:
sending, to a device, the output data; and
causing the device to display to the output data and the first log message.

9. The computer-implemented method of claim 8, further comprising:
receiving, from the device, an input confirming the first log message is anomalous;
storing feedback data in response to receiving the input, the feedback data associated with the first log message; and
configuring the first machine learning model or a second machine learning model using the feedback data, the second machine learning model configured to determine that an input log message is of interest to a user associated with the device.

10. A computing system for detecting an anomalous message in a machine-generated log, the system comprising:
at least one processor; and
at least one memory comprising instructions that, when executed by the at least one processor, cause the computing system to:
receive a plurality of log messages of the machine-generated log;
process the plurality of log messages to determine a first process tag associated with a first log message of the plurality of log messages and a second process tag associated with a second log message;
select, from a plurality of machine learning models, a first machine learning model corresponding to the first process tag;
process the first log message using the first machine learning model to determine model data;
determine, using the model data, that the first log message is potentially anomalous;
determine, using the model data, an explanation for determining that the first log message is potentially anomalous; and
generate output data including the explanation and an indicator that the first log message is anomalous.

11. The computing system of claim 10, wherein the at least one memory further comprises instructions that, when executed by the at least one processor, further cause the computing system to:
process the first log message using the first machine learning model to determine a first score, the first score representing a likelihood that the first log message is potentially anomalous,
wherein the output data is further generated based on the first score satisfying a condition.

12. The computing system of claim 11, wherein the at least one memory further comprises instructions that, when executed by the at least one processor, further cause the computing system to:
process the first log message using a second machine learning model to determine a second score corresponding to the first log message, the second score representing the first log message is of interest to a user,
wherein the second machine learning model is configured using inputs received from the user, the inputs indicating a first set of log messages of interest to the user and a second set of log message of non-interest to the user.

13. The computing system of claim 12, wherein the at least one memory further comprises instructions that, when executed by the at least one processor, further cause the computing system to:
determine a third score, based at least in part on the first score and the second score, corresponding to the first log message; and
determine that the third score satisfies a condition,
wherein generating the output data is further based on the third score satisfying a condition.

14. The computing system of claim 10, wherein the at least one memory further comprises instructions that, when executed by the at least one processor, further cause the computing system to:
determine feature data corresponding to the first log message,
wherein the first machine learning model is a random forest model, and
wherein processing the first log message using the first machine learning model comprises processing the feature data using the random forest model.

15. The computing system of claim 14, wherein the model data corresponds to a traversal path taken in processing the feature data using the random forest model, and
wherein the explanation is determined based at least in part on the traversal path and a decision threshold corresponding to at least one feature included in the feature data.

16. The computing system of claim 14, wherein the feature data includes a first feature representing a word in the first log message and a second feature representing a numerical value in the first log message.

17. The computing system of claim 10, wherein the at least one memory further comprises instructions that, when executed by the at least one processor, further cause the computing system to:
send, to a device, the output data; and
cause the device to display to the output data and the first log message.

18. The computing system of claim 17, wherein the at least one memory further comprises instructions that, when executed by the at least one processor, further cause the computing system to:
receive, from the device, an input confirming the first log message is anomalous;
store feedback data in response to receiving the input, the feedback data associated with the first log message; and
configure the first machine learning model or a second machine learning model using the feedback data, the second machine learning model configured to determine that an input log message is of interest to a user associated with the device.

19. At least one non-transitory, computer-readable medium may be encoded with instructions which, when executed by at least one processor included in a system, cause the system to:
receive a plurality of log messages of a machine-generated log;
process the plurality of log messages to determine a first process tag associated with a first log message of the plurality of log messages and a second process tag associated with a second log message;
select, from a plurality of machine learning models, a first machine learning model corresponding to the first process tag;
process the first log message using the first machine learning model to determine model data;
determine, using the model data, that the first log message is potentially anomalous;
determine, using the model data, an explanation for determining that the first log message is potentially anomalous; and
generate output data including the explanation and an indicator that the first log message is anomalous.

20. The at least one non-transitory, computer-readable medium of claim 19, further encoded with instructions which, when executed by at least one processor included in a system, cause the system to:
determine feature data corresponding to the first log message,
wherein the first machine learning model is a random forest model, and
wherein processing the first log message using the first machine learning model comprises processing the feature data using the random forest model.
